(19) United States
(12) Patent Application Publication
(10) Pub. No.: US 2003/0051103 A1
(43) Pub. Date: Mar. 13, 2003

(54) Shared memory system including hardware memory protection

(76) Inventors: Mike Lardner, Tuam (IE); Sean Boylan, Galway (IE)

Correspondence Address: NIXON & VANDERHYE P.C., 8th Floor, 1100 North Glebe Rd., Arlington, VA, 22201-4714, US

(21) Appl. No.: 09/968,937

(22) Filed: Oct. 3, 2001

(30) Foreign Application Priority Data
Sep. 5, 2001 (GB) 0121402.2

(51) Int. Cl. G06F 13/00

(52) U.S. Cl. 711/147

(57) ABSTRACT

A system on a chip has a plurality of processors coupled to a common memory and a hardware protection block which extracts a source ID and memory address data from a memory transaction to determine whether the transaction is destined for a permitted region of memory allotted to the respective processor.

### REFERENCE TO RELATED APPLICATIONS

Pratt et al., Ser. No. 09/879,065 filed Jun. 13, 2001, commonly assigned herewith and incorporated by reference herein.

Creedon et al., Ser. No. 09/893,659 filed Jun. 29, 2001, commonly assigned herewith and incorporated by reference herein.

Hughes et al., Ser. No. 09/893,658 filed June 29, 2001, commonly assigned herewith and incorporated by reference herein.

Boylan et al., Ser. No. not yet allotted, entitled ‘AUTOMATIC GENERATION OF INTERCONNECT LOGIC COMPONENTS’, filed Aug. 2, 2001, commonly assigned herewith and incorporated by reference herein.

### FIELD OF THE INVENTION

This invention relates to data systems, particularly application specific integrated circuits, which include data buses which are required to convey (particularly in a write operation) data signals from a variety of sources to a common data memory, and/or to obtain (i.e. in a read operation) data signals for a variety of initiators from a common memory The invention is particularly intended for use in substantially self-contained data handling systems, sometimes called ‘systems on a chip’ wherein substantially all the functional blocks or cores as well as programmed data processors are implemented on a single chip, with the possible exception of at least some of the memory, typically static or random access memory required to cope with the operational demands of the system.

More particularly, the invention relates to the protection of one or more of the common memories against the effects of an error in a core (i.e. a functional block with a DMA engine) or a processor by means of a hardware protection scheme preferably incorporating minimum delay or latency.

### BACKGROUND TO THE INVENTION

As is described, for example, in the aforementioned co-pending patent applications Ser. Nos. 09/893,658 and 09/893,659, systems on a chip may be organised so that substantially all exchanges of data messages between cores and/or processors in the system take place by way of one or more common memories which may be disposed on or off chip. In the systems described in those applications and also other systems on a chip wherein at least one memory is shared between a multiplicity of processors and/or DMA engines, a shared memory provides a mechanism for inter-processor communication and therefore typically contains status and control information which is vital to the operation of the system. If one of the processors or DMA engines enters an uncontrolled state, as a result of, for example, a software flaw, it has the potential to corrupt data within the shared memory. This may have catastrophic effect, in that an error in one processor can potentially corrupt the operation of the entire system. It is accordingly desirable to provide a protection scheme for the shared memory to inhibit the corruption of the state of the shared memory by reason of a fault in a single processor or core.

It is feasible to provide software based protection. In a software protection scheme one of the processors in the system may manage the allocation of regions of the shared memory and the memory management software within each of the individual processors may subsequently ensure that only respectively allocated regions are accessed by a given processor. If the individual processors had dedicated memory management units (MMUs), then it may be possible to extend such a scheme so that the MMU for each individual processor prevents access by that processor to regions of the shared memory which have not been allocated by that processor. This can provide stronger enforcement of the memory allocation rules for that processor.

However, purely software based protection schemes are vulnerable to design flaws within the software. Even with a rigorously defined memory management scheme for the shared memory, a single stray pointer in one processor has the potential to corrupt the state of the entire system.

Using an existing MMU to enforce the memory management scheme is only an option if all the processors and DMA engines sharing common memory have dedicated MMUs. Since an MMU is typically a complex and large block of logic, it is not in general desirable for the majority of processors and DMA engines within a system on a chip to have such a feature. If only one processor within the ASIC is lacking a dedicated MMU, then a software fault in that processor can corrupt the shared memory despite the fact that all other processors of DMA engines are using their MMUs to protect the shared memory.

Additionally, such MMUs typically lack the ability to implement fine grained control of the protected region. Shared memory is often used to implement small mailbox regions between processors. In order to provide the required protection matrix it may be necessary to provide protection on a byte-wide granularity. Most MMUs are unsuited for such a task.

The present invention is based on protection of a shared memory by means of hardware (preferably constituted by buffers and at least one state machine) immediately before the memory. In a typical embodiment of the invention, processors and DMA engines which share access to the memory are coupled to a memory controller by a memory bus system which preferably includes at least one arbitration stage which enables the ‘winner’ of a round of arbitration to access the shared memory at a particular address. A table of set-up information, which may be implemented as an array of programmable registers, may determine which regions of the memory are accessible by which processor or DMA engine. If the request by the winner of an arbitration conforms to the rules embodied in such a table, access may proceed. If the access request violates the rules, as is likely to occur if the source of the request has entered a flawed state, then the protection enforcement scheme can refuse the request. The arbitration stage can then service the next request for access to the shared memory. In such a scheme, the contents of the shared memory have not been corrupted by the erroneous request from the first winning processor or DMA engine.

Thus the potential of an error state in one processor to corrupt the overall system state via corruption of shared memory can be avoided by denial of access to the shared memory.

The present invention is particularly suitable for use in a scheme of ‘posted’ read and writes described in the aforementioned co-pending application for Hughes et al., Ser. No. 09/893,658. In the system described in that application, a write request from a core or processor is sent towards a target (i.e. the shared memory) along with source and transaction identifiers. The source identifier is preferably a number unique (within the chip) to the respective source. The transaction identifier is preferably a number in a cyclic sequence. The scheme is preferably implemented with a multiple line parallel memory bus system in which dedicated lines are provided for the source and transaction identifiers. Similarly, a read transaction may be sent from an initiator to a target memory, the read transaction including a read request as well as source and transaction identifiers. In the system described in Hughes et al., supra, the source identifiers are used to enable acknowledgements of a write request to be sent to a source and to enable a decoding of the path the read transaction (including the data read from the memory) should take when the data is returned from the target memory to the initiator.

However, the source identifiers may additionally be used in a preferred embodiment of the present invention to access a protection table to obtain the addresses identifying partitions in the shared memory delimiting the respective region associated with the source identified by a particular source identifier. A comparison of the write address data or the read address data contained in the memory transaction (i.e. write or read request) with the signals identifying the region of the memory will provide an indication whether the respective core or processor is requesting access, either for reading or writing, to the correct region of memory and therefore provides a control by means of which the request can be blocked, and preferably removed from the memory controller, if the core or processor is improperly requesting access to an unauthorised section of memory.

Further objects and features of the invention will be apparent from the following detailed description with reference to the accompanying drawings.

### BRIEF DESCRIPTION OF THE DRAWINGS

FIG. 1 is a schematic diagram of a bus system.

FIG. 2 is a schematic diagram of an arbiter in respect of an upward path therein.

FIG. 3 is a schematic diagram of an arbiter in respect of a downward path therein.

FIG. 4 illustrates a read command cycle.

FIG. 5 illustrates one embodiment of memory protection according to the invention.

FIG. 6 illustrates a protection system in more detail.

FIG. 7 illustrates the operation of a state machine.

FIG. 8 illustrates a modification to the system shown in FIG. 5.

### DETAILED DESCRIPTION OF A PREFERRED EMBODIMENT

In order to set an embodiment of the invention in an appropriate context, there will first be described a system on a chip which corresponds to the system described in the aforementioned co-pending patent applications for Creedon et al. and Hughes et al.

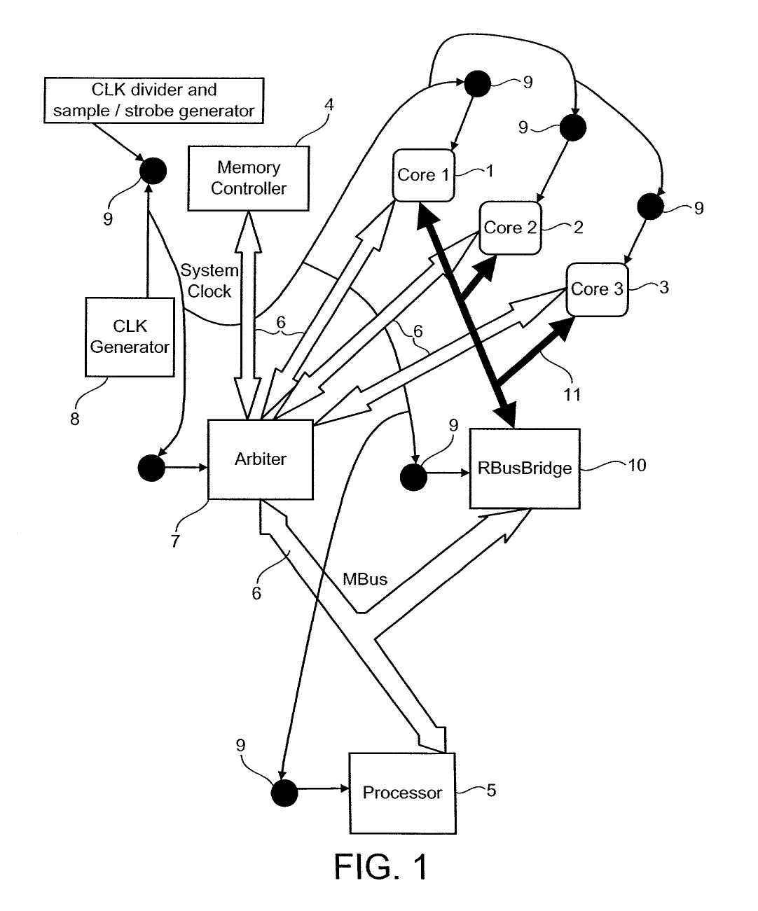

FIG. 1 is a schematic diagram showing basic elements which support a data bus system according to the invention. In the example shown in FIG. 1 there are three ‘cores’, 1, 2 and 3, which contend for access to a memory (not shown) under the control of a memory controller 4. The cores are connected to the memory by way of a memory bus 6, which is shown as extending between the cores and the memory controller by way of an arbiter 7. It is assumed in this example that the memory controller 4 has only one memory bus interface in the sense towards the memory controller.

The memory bus, denoted herein as ‘mBus’, constitutes the mechanism for the processor 5 and/or the cores 1, 2 and 3 to read from and write to locations in the memory. Thus ‘mBus’ as used herein signifies a direct memory bus to and from the memory.

The memory bus has a multiplicity of lines, as well as associated lines, which are described herein. The physical implementation will not be described because the scheme of the present invention is intended to be independent of the particular physical realisation.

The memory bus (mBus) may be implemented as a ‘half-duplex’ bus so that the same signals are used for both read and write transactions. However, full duplex operation is feasible as described in the aforementioned co-pending applications for Hughes et al. and Creedon et al.

Also shown in FIG. 1 is a ‘processor’ 5 which, in addition to exchanging data messages with the memory, can read or write signals in registers within the cores 1, 2 and 3. The processor could be coupled to those register directly by way of a register bus 11 but merely be way of example it is assumed for FIG. 1 that the processor 5 has only a memory bus interface and that signals to or from the register bus 11 need translation by a bridge 10, denoted ‘rBusBridge’.

Also shown in FIG. 1 is a clock generator 8 which provides a system clock to a multiplicity of ‘clock divider and sample/strobe generators’ 9 which will normally perform clock division, to derive sub-multiples of the system clock. Preferably but not essentially these generators 9 are organised as described in co-pending application Ser. No. 09/879,065 for Pratt et al., which describes a clock system wherein derived clocks have a particular relationship with a system clock. As is described in the aforementioned application, the particular clock system or complex is organised so that the sub-multiple clocks must occur on defined edges or transitions of the system clock and different transitions are employed for clocking data into a block or core and for clocking data out of a block or core. The main purpose is to minimise the use of synchronisers or ‘elastic’ buffers. Clock generators 9 provide sample and strobe clocks as described in Pratt et al., in order to restrict the clocking of data to selected ones of the various possible transitions. This is particularly important where data is transferred between different clock domains.

Elements of mBus

The mbus 6 may physically be implemented in known manner to have the address/data lines and other select and control lines which carry the signals described below.

‘mBusWrData’ denotes a multiple-bit multiplexed data/address bus. During the first phase of a transaction the address is placed on the bus and during the second and subsequent phases data is placed on the bus. The bus may be 32 bits wide but any other reasonable width may be employed.

‘mBusWrSel’ denotes a select signal (or the corresponding line) which is used to select the target of the transaction. In the example shown in FIG. 1 there would be two ‘select lines’ from the processor 5, one to select the arbiter 7 as a target and the other to select the rBusBridge. The arbiter 7 has one select line to select the Memory Controller and the cores have one select line each to select the arbiter 7 as a target.

‘mBusWrInfo’ denotes a signal which gives information on the transaction in progress. It contains the source and transaction identifiers during the address phase and contains ‘byte valids’ during the data phase. On the last data phase of the transaction, as well as containing the byte valids it also contains a request to acknowledge the transaction.

‘mBusWrAck’ is the corresponding acknowledgement, for the transaction that requested an acknowledgement on completion.

The control signals (on corresponding lines) for the bus are as follows:

(i) ‘mBusWrPhase’ is a two-bit signal which can have four values, denoting start of frame (SOF), normal transmission (NORMAL), idle (IDLE) and end of frame (EOF).

(ii) ‘mBusWrRdy’ is a single bit which if set indicates that the target is ready to accept a new transaction.

(iii) ‘mBusWrBrstRdy’ indicates that the target is ready to accept a burst.

(iv) ‘mBusWrEn’ is an enabling signal which indicates that a transaction is either a read or a write.

In respect of the present invention only the address signals and the source identifiers are important.

rBus

Also in the example shown in FIG. 1 the processor 5 may have access to the cores via another bus, a register bus 11 denoted herein as ‘rBus’. The rBus 11 is somewhat different to and simpler than the mBus. The processor 5 uses the rBus 11 to read from and write to registers in the cores. The registers which determine or indicate, for example, the operational mode of a core can be accessed only through rBus. In this example the processor has only a mBus interface so the bridge 10 is used to translate mBus signals into rBus signals and vice-versa.

The register bus (rBus) is not particularly relevant to the present invention and will not be described in detail. Reference should be made to the aforementioned patent applications for Creedon et al. and Hughes et al. for a fuller description, if required, of the register bus and the signals which appear on it.

Arbiter

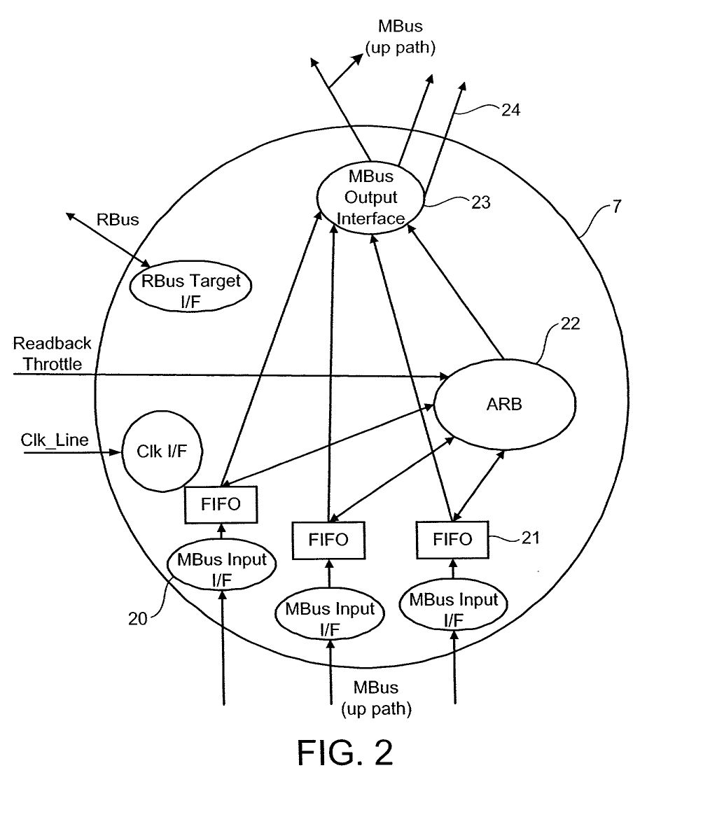

The arbiter 7 in FIG. 1 is preferably in two parts, called herein the ‘upward path’ and the ‘downward path’. FIG. 2 illustrate the upward path, i.e the direction in which data passes from a core or the process to the memory controller 4. The arbiter includes an ‘mBus Input Interface’ 20 for each initiator (i.e. each core or processor connected by a section of the bus 6 to the arbiter 7). This interface block 20 clocks input (write) data into the arbiter on a negative edge of the arbiter's clock. The clock interface is shown schematically at 26.

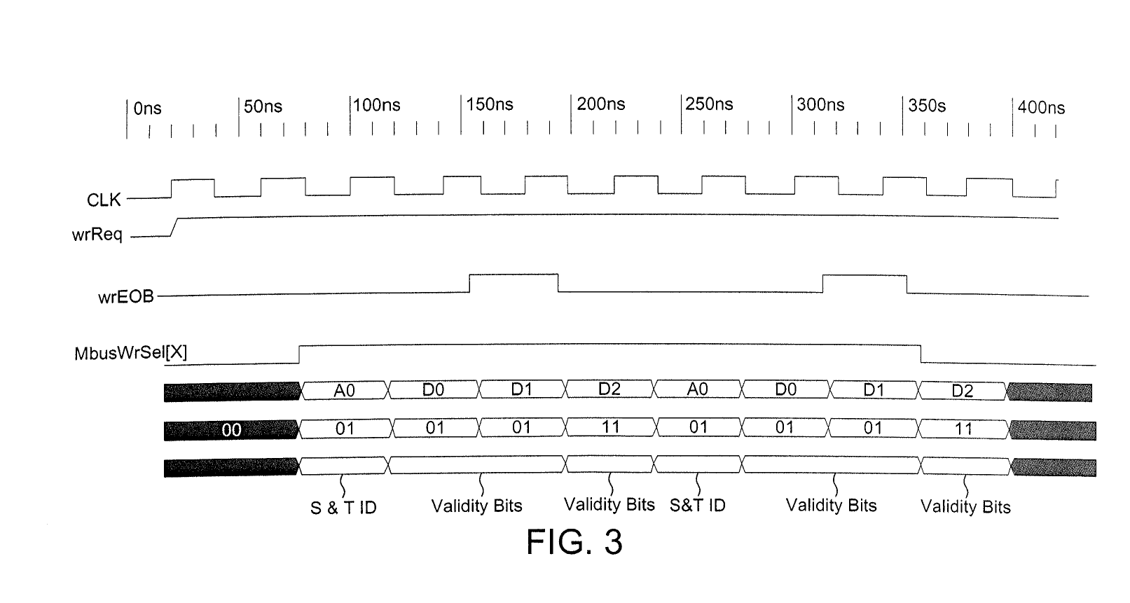

The arbiter contains one FIFO 21 for each initiator. Each FIFO 21 is coupled to a respective interface 20 and the write or read Request data is stored in the FIFO while waiting to be granted access to the arbiter's output port. Each FIFO may be of selectable depth and needs a width at least equal to the sum of the widths (i.e. number of bits) of the ‘data’, ‘phase’ and ‘info’ signals described in relation to FIG. 3 (and an enable signal also in a practical scheme). In a typical example these widths are (32+2+16+1)=51 bits.

A block 22 denoted ‘Arb’ performs the arbitration algorithm. The particular algorithm is not important. It may for example employ TDMA (time-division multiple access) giving high priority to some initiators and low priority to others. The Arb block 22 will also decode the destination address and assert a corresponding select line.

The arbiter contains a single ‘mBus Output Interface’ 23 which is coupled to the up path of the mBus 6 and select lines 24. It contains a multiplexer to choose the correct output data, which is controlled by the Arb 22. It also clocks out data on the positive edge of the clock controlling the arbiter.

The ‘rBusTarget Interface’ 25 is coupled to the rBus 11 and contains registers for the arbiter. They may contain or define priorities and slots for the arbiter's algorithms and can be written over the rBus. The registers contain threshold values for FIFOs, to tell the FIFOs when to request arbitration.

FIG. 2 also shows a clock interface 26 coupled to a clock line 27. The readback throttle 28 is a signal which indicates that a readback FIFO is full and is unable to receive any more requests.

The arbiter will include a ‘downward path’ for signals from memory back to a selected core or processor. The downward path is not relevant to the present invention and if required details of it are given in the aforementioned co-pending applications of Hughes et al. and Creedon et al.

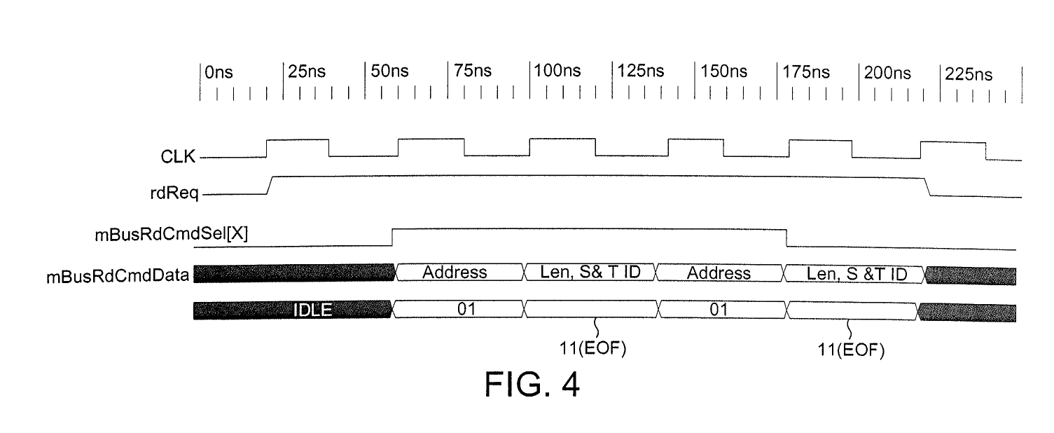

The object of the arbiter in the upward direction, as described in the aforementioned patent applications, is to achieve at each arbitration access for the winner of the arbitration to the memory controller and thence to the common memory. Typical signals which appear on the memory bus for the read and write request transactions will be described in relation to FIGS. 3 and 4.

Memory Bus Signals

FIG. 3 is a somewhat simplified diagram illustrating the principal relevant signals that appear on a memory bus as described in FIG. 1 and the aforementioned co-pending applications of Hughes et al. and Creedon et al. For the sake of simplicity, a variety of signals, such as acknowledgement request signals, acknowledgement signals, enable signals and such like have been omitted.

As shown in FIG. 3, the signals are defined in relation to a relevant clock signal (CLK). A ‘write’ transaction is initiated by a wReq signal which is a 1-bit signal, on a single line, going halfway to mark the start of the transaction. Since each core or processor may have a bus connection to a multiplicity of different arbiters, there is in general a multiplicity of select lines one of which is selected by the relevant select signal, shown in FIG. 3 as the ‘mBusWrSel[X]’ signal.

In the present example it is assumed that the memory bus is a multiplexed bus in which the address data appears in a particular clock cycle and is followed by a selectable number of cycles of a data signal. These signals are shown on the line denoted ‘mBusWrData’, which indicates a 32-bit parallel signal. In a first clock cycle the address appears, and is followed by three clock cycles in which data appears, these cycles being denoted D0, D1 and D2.

On respective lines of the bus there is a phase signal, which is a 2-bit signal denoted in FIG. 3 as ‘mBusWrPhase’. The ‘phase’ signal may take four values, of which the value ‘00’ denotes an idle or null state, ‘01’ denotes data which has an incrementing address, ‘10’ denotes data with a non-incrementing address, and ‘11’ denotes the end of the frame on the last data word. In the example shown in FIG. 3, the address and data both have incrementing addresses whereas the last data cycle D2 is denoted ‘11’.

Of most importance relative to the present invention, nine lines of the bus, in this example, are occupied (when the address signal is present) by the ‘information’ herein denoted ‘mBusWrInfo’. This comprises, in this example, a 6-bit source identification field and a 3-bit transaction identifier field. As is described in the co-pending applications, when data bits are on the bus, these lines carry validity signals of no importance to the present invention.

As described in the aforementioned co-pending application of Hughes et al., the source identification field is employed to identify uniquely each core or processor in the system on the chip. The transaction ID is a 3-bit number which re-cycles. The general purposes of these signals are to avoid ‘freezing’ a path to memory while completing a transaction, to facilitate the return of data to a source request, and also to facilitate possible re-ordering of transactions, particularly read requests. These functions are not directly relevant to the present invention and are in any event fully described in Hughes et al. However, the source identification, which is an important part of the posted reads and writes, can be employed in the present invention as described later.

FIG. 4 illustrates a corresponding read transaction. The line denoted ‘mBusRdCmdSel’ is a select signal, the line denoted ‘mBusRdCmdData’ is a multiplexed signal which denotes alternately an address and signals which identify the length of a burst, the source and transaction identifiers, and the line marked ‘mBusRdCmdPhase’ is a phase signal which is of similar significance to the phase signal in a write transaction.

Hardware Memory Protection

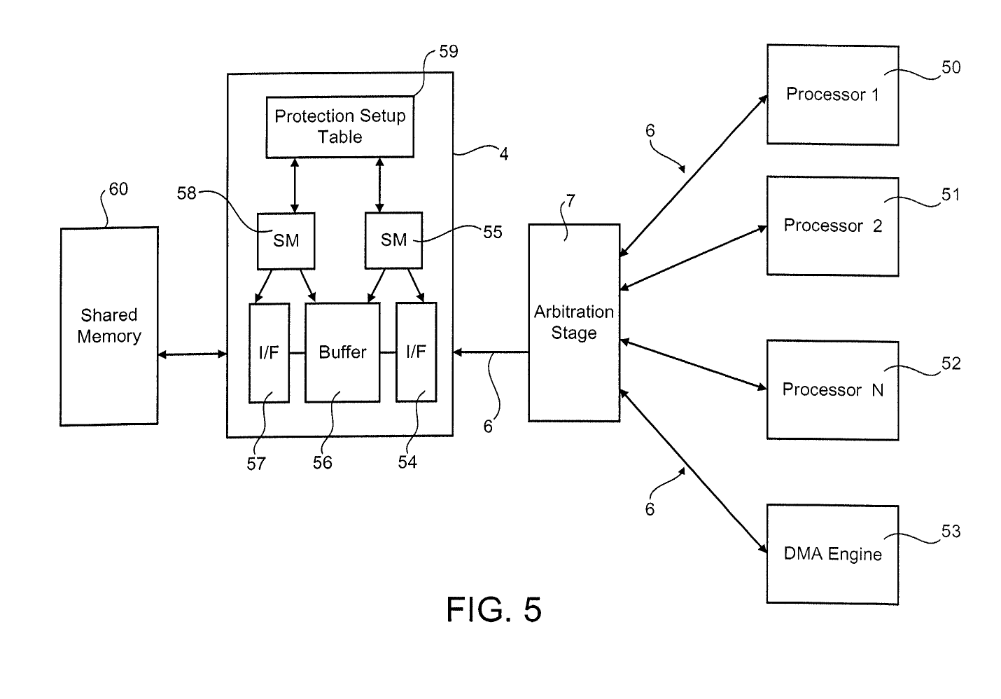

FIG. 5 illustrates one example of the present invention incorporated within a system as previously described.

FIG. 5 includes an arbitration stage 7 which is connected by memory bus segment 6 to a multiplicity of processors 50, 51 and 52 and to a core 53 having a DMA engine. As previously described with reference to FIG. 1 and elsewhere, the arbitration stage is coupled to the shared memory (not shown in FIG. 1) by a memory controller 4. In essence the memory controller decodes the data bus signal's output from the arbitration stage 7 so as to control access to the shared memory 60.

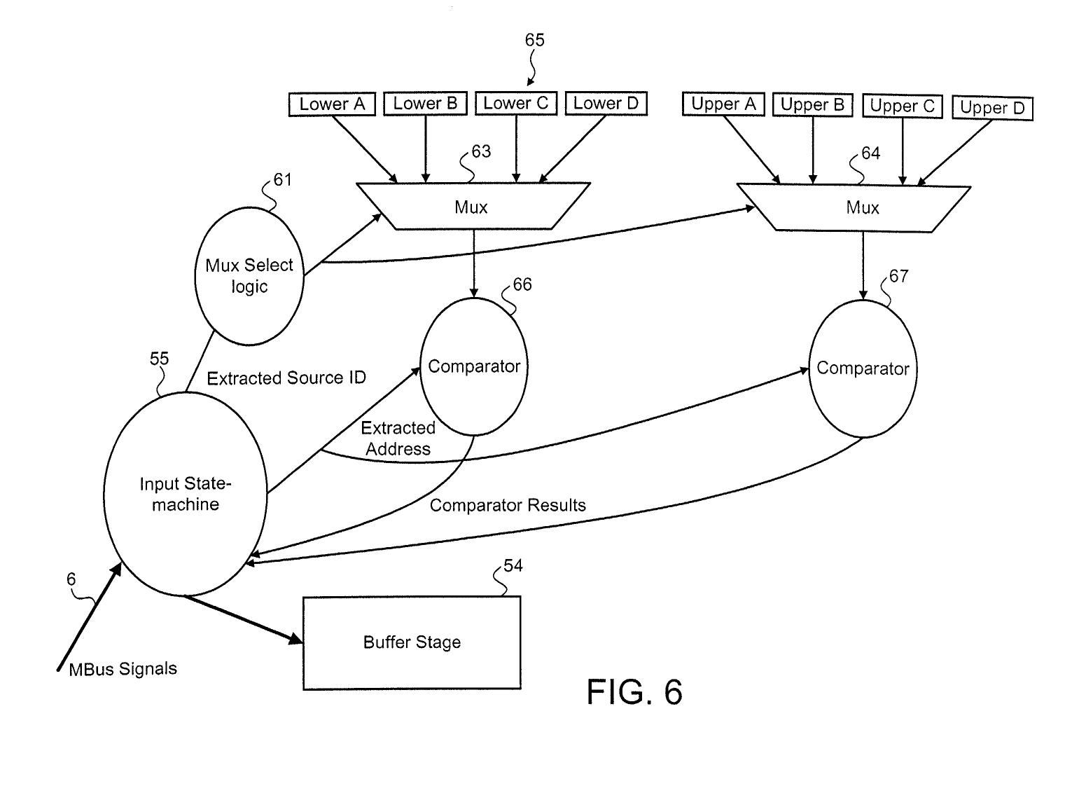

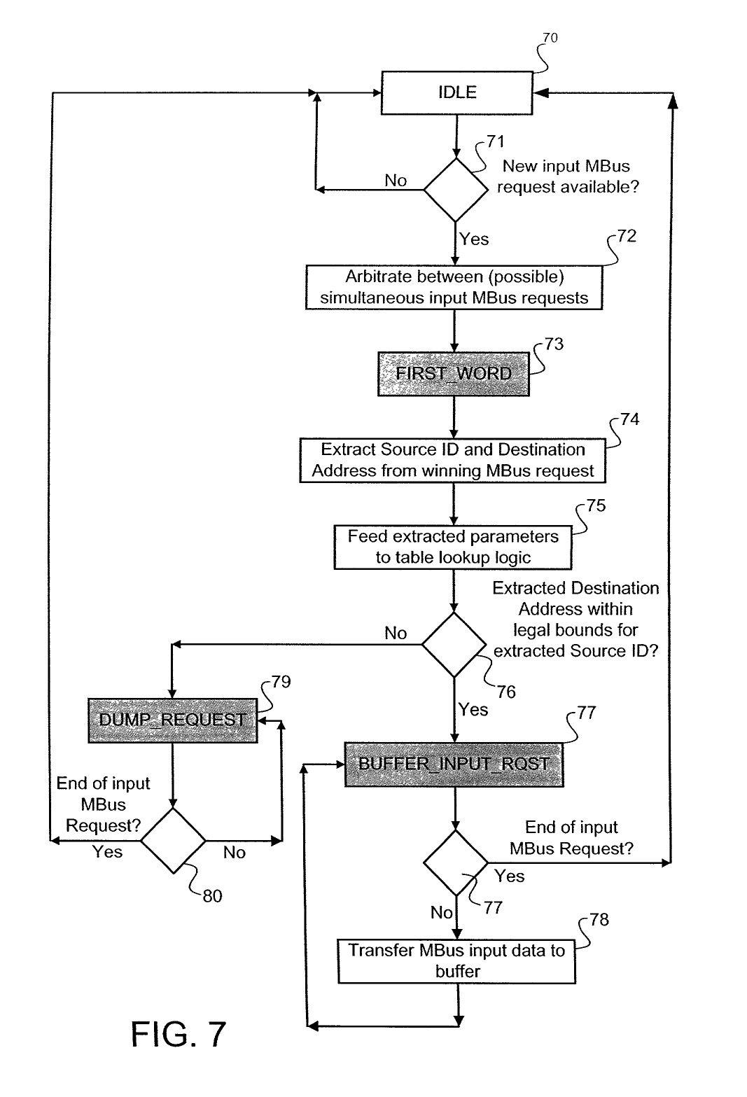

In this example, the memory controller 4 has an interface 54 coupled to the memory bus section from the arbitration stage 7. As is described in more detail with reference to FIGS. 6 and 7 a state machine 55 extracts address data and the source identification from the memory transaction (i.e. read or write request) from the memory bus. The transaction is preferably placed in a buffer element 56. At the output side of the buffer is an interface 57 controlled by a state machine 58 which has recourse to the buffer 56. The state machine 58 examines the contents of the buffer and performs a read or write on the actual memory interface.

The organisation of the input state machine 55 and the output state machine 56 and the allotment of tasks between them is to some extent a matter of preference. It is preferable that the input state machine controls the basic determination whether the memory transaction, particularly a write request, should be allowed to proceed to the memory. For this purpose, as noted above, it needs to extract the relevant address data from the memory transaction. The source identification can be used to determine which stored limits should be selected for comparison with the address data. The output state machine depends mainly on the interface characteristics of the shared memory. It is required to generate (in a manner not primarily relevant to the present invention) the required signalling to transfer the memory transaction such as the write request to the actual memory.

The buffer 56 in FIG. 5 may be a simple FIFO buffer of which the important purpose is to de-couple the input state machine from the output state machine. As is described in more detail with reference to FIGS. 6 and 7, the input state machine will, dependent on the comparison of address data with the relevant limits determined by the extracted source identification, allow a memory access to request to pass into the buffer 56. Subsequently the output state machine will read from that buffer and convert the buffered memory bus transaction into a signalling sequence which is specific to the target memory.

As will also be explained, although it is feasible in modern ASIC technology to employ a comparatively simple buffering system. Systems employing very high frequencies or very complex look-ups might require a pipelined buffering architecture. In such systems it may be appropriate, for example, for the input state machine to put the memory transaction into the buffer and to make the determination of whether to allow the transaction to proceed to memory, but allot the task of actually executing that decision to the output state machine. The output state machine would of course have available to it the protection rules (constituted by the signals defining the permitted areas of memory allotted to each processor) as well as the target write address and source identifier which will have been extracted by the input state machine.

The specific embodiment of the present invention assumes that the levels of logic required to implement the protection look-up can be implemented in a single clock cycle for usefully sized tables (generally up to 512 register locations) at typical shared memory speeds (typically in the range 25 MHz to 100 MHz). Very typically it takes somewhat longer, such as several clock cycles, to transfer a memory transaction such as a read or write request to the shared memory than it does to perform the look-up which the preferred form of the invention requires and which can usually be performed within a single clock cycle. It is feasible for the look-up for one transaction to be performed while a previously validated transaction is being transferred to the shared memory; it would normally be sufficient for the FIFO structure to have sufficient capacity.

Under normal circumstances the comparison of the write request parameters to the contents of the protection table can be implemented in a single clock cycle for a typical configuration of four processors.

TABLE 1

| | Access Range (Lower | Access Range (Upper |
|---|---|---|
| Source | Address) | Address) |
| Source ID for | Lower boundary of | Upper boundary of |
| Processor 1 | address range which | address range which |
| | Processor 1 is allowed | Processor 1 is allowed to |
| | to access for writes | access for writes |
| Source ID for | Lower boundary of | Upper boundary of |
| Processor 2 | address range which | address range which |
| | Processor 2 is allowed | Processor 2 is allowed to |
| | to access for writes | access for writes |
| Source ID for | Lower boundary of | Upper boundary of |
| Processor 3 | address range which | address range which |
| | Processor 3 is allowed | Processor 3 is allowed to |
| | to access for writes | access for writes |
| Source ID for | Lower boundary of | Upper boundary of |
| DMA Engine | address range which | address range which |
| | DMA Engine is allowed | DMA Engine is allowed |
| | to access for writes | to access for writes |

TABLE 2

| | Access Range (Lower | Access Range (Upper |
|---|---|---|
| Source | Address) | Address) |
| 1 | 0 × 0000 | 0 × 0FFF |
| 2 | 0 × 1000 | 0 × 17FF |
| 3 | 0 × 1800 | 0 × 37FF |
| 4 | 0 × 3800 | 0 × 3FFF |

Table 1 illustrates a typical structure for the arrangement shown in FIG. 9. The table is accessed by the source identifier for the processors and yields a respective access range denoted by the lower and upper boundaries of the address range into which processor is allowed access.

Table 2 illustrates a typical value for the protection table entries in a 16 kilobyte shared memory. It allows processor 1, which has a source ID of unity to perform write accesses to a 4 kilobyte region. The processor 2 has a source ID of two and has access to a 2 kilobyte region. Processor 3 has access to an 8 kilobyte region and the DMA engine has access to a 2 kilobyte region. The lower and upper addresses in Table 2 define the limits of the respective region.

FIG. 6 illustrates in more detail a preferred form of the memory protection system. FIG. 7 illustrates a preferred organisation of state machine 55.

In the system shown in FIG. 6, memory transactions constituted by ‘mBus signals’ are received on the section of memory bus 6 and are sensed by the input state machine 55. The state machine extracts, by sensing the signals on the respective dedicated lines, the source identification (source ID) of the memory transaction and provides it to Mux Select Logic 61. The write address is also extracted and coupled to the comparators 66 and 67.

The Mux Select Logic 61 has recourse to four registers A, B, C and D in a set of registers 62. The extracted source ID is compared with the source IDs in registers 62 to determine whether it is a processor of which the access to the memory must be controlled by means of the protection logic. If there is a match between the source ID and a value in the relevant register in the set 62, the Mux Select Logic will generate the required signals for operating the multiplexers 63 and 64.

In the present embodiment there are four possible valid inputs to the Mux Select Logic, that is to say the source IDs, termed for convenience in FIG. 6 as A, B, C and D. These source IDs are compared against stored values representing the lower and upper limits of the address space which is allotted to each of the four processors.

The limits are held in a set of registers, so that it is possible to examine the contents of all the register locations simultaneously. This is preferable to employing a separate memory with an access-request bottleneck.

The registers 65 in FIG. 6 are denoted ‘Lower A’, Lower B’ etc denoting the lower limits and ‘Upper A’, ‘Upper B’ etc to denote the upper limits of the respective memory spaces. A multiplexer 63 will select the relevant lower limit whereas the multiplexer 64 will select the respective upper limit. Thus for example if the input to the Mux Select Logic is the source ID for processor D, multiplexer 63 is controlled to select the limit value ‘Lower D’ from the respective register and the multiplexer 64 is operated to select the limit value ‘Upper D’ from the respective register.

The extracted address is compared with the lower limit by means of comparator 66 and the upper limit by means of comparator 67. Thus the input state machine can derive a true/false determination depending on whether the current address falls in the allotted or ‘legal’ region. In a simple case, comparator 66 may set a single bit on a line if the extracted address is greater than the lower limit whereas comparator 67 may set a single bit on a line if the selected address is lower than the upper limit.

In a typical example, where the memory has a 16-bit address bus, 148 registers will be required, namely 64 (4×16) to store the lower address value, 64 registers likewise to store the upper address value and 20 (4×5) to record the source ID value where there are five bits in the source ID address. The various registers may be set by means of the rBus.

FIG. 7 is a diagram illustrating the operation, that is to say the progression of states, of the input state machine 55. From an idle state 70 the machine will transition to an arbitration state 72 if a new input mBus request (i.e. a memory transaction) is available. The arbitration stage may not be essential since the arbiter 7 should have arbitrated between a multiplicity of memory transactions from the various cores and processor to determine which single mBus request should be forwarded at any given time. However, it may be desirable to include state 72 to guard against the possibility of simultaneous input mBus requests, or in a system which does not have a prior arbitration stage 7.

The FIRST_WORD state 73 denotes the reception of the mBus request or the first word in it. State 74 denotes the extraction of the source ID and the destination address (related to the common memory) and state 75 denotes the feeding of the extracted parameters (i.e. the source ID and destination address or possibly parts thereof, to the table look-up logic, namely the Mux Select Logic and the comparators.

Decision 76 is determined by the comparator results from comparator 66 and 67 and indicates whether the extracted destination address is within the legal bounds for the extracted source ID.

If the destination address is within the legal bounds, the input mbus request is directed, state 77, to the buffer stage 54. Decision 77, denoting the possible end of the mBus request (which may constitute a plurality of words) has ended or not. If it has not ended, the mBus input data is transferred to the buffer. If the mBus request has terminated the state machine reverts to the idle state 70.

If the extracted destination address is not within legal bounds for the extracted source ID (decision 76), the dump request state 79 is entered. The mBus request is monitored to its end (decision 80). When the input mBus request terminates, the state machine can revert to the idle state 70.

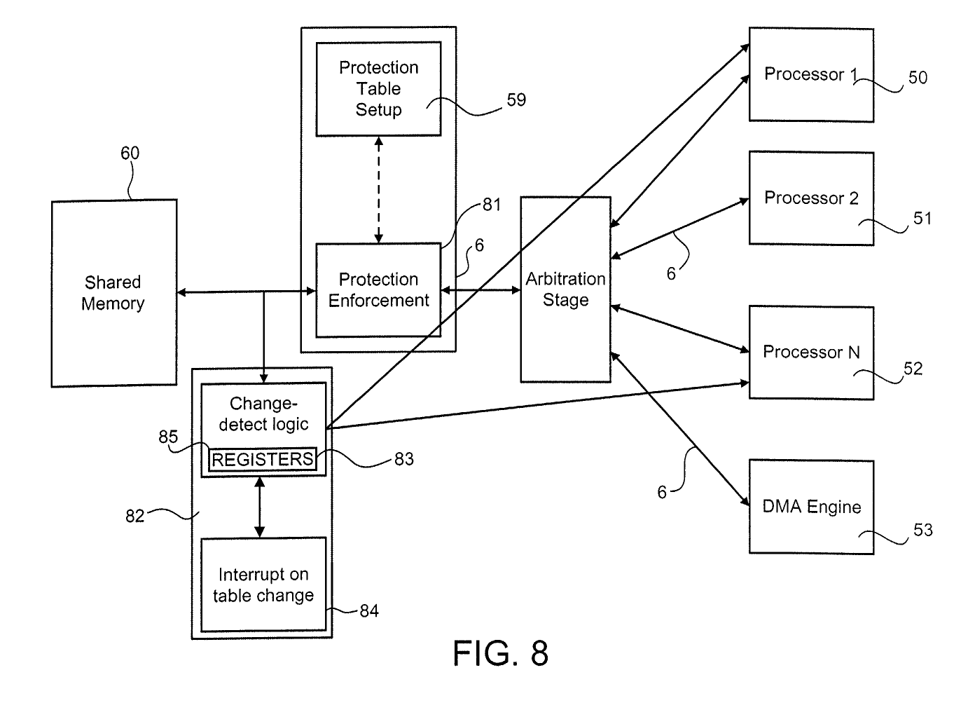

It would be feasible to modify the input state machine to allow buffering and thereby passage to the memory, of a memory transaction from a core, such as a core with a DMA engine, of which the source ID was not in the register 62. Such scheme may be appropriate if (for example) non-processor cores accessed the memory with read requests only. Alternatively, the state machine may be organised so that in the absence of a stored source ID matching the extracted source ID the transaction is dumped. This can easily be implemented by means of a decision stage after stage 75 in FIG. 8. An advantage of the latter option is that, if desired, a particular core can be ‘dynamically’ prevented from accessing the memory, even though a physical path to the memory exists, by removing the respective source ID from the register 62.

FIG. 8 illustrates a modified system wherein block 81 is intended to represent the stage machine's interfaces and buffer described with reference to FIG. 5. Since the shared memory is typically used to allow inter-processor communication it is advantageous to incorporate additional hardware assist for such communications. For example, during inter-processor communication, a processor may wish to indicate a change in status to a second processor by means of setting or clearing a flag bit at a particular location within the shared memory. The second processor would typically be required to poll that status flag to observe the change in status. Such a polling operation wastes valuable processing cycles within the second processor. The change detect block in FIG. 8 can be set up to monitor the status flag and to interrupt the second processor when a change is detected.

Table 3 is an example of an ‘interrupt-on-change’ table 84 which can be maintained within a hardware unit 82 including a ‘change-detect’ block 83. This unit can be under the control of registers which are monitored and controlled by way of the rBus by a respective processor. By adding entries to this table, a particular bit (i.e. ‘Bit Location’) within a particular address (i.e. ‘Address’) can be monitored for a change in value. On detection of such a change, the defined interrupt to a particular processor can be raised. The interrupt may be directed to the appropriate core or processor by way of a respective control bus, organised for example as described in the co-pending application of Boylan et al.

TABLE 3

| Address | Bit Location | Interrupt to raise |
|---|---|---|
| 0 × 0008 | 5 | 0 |
| 0 × 0008 | 1 | 1 |
| 0 × 1f00 | 0 | 2 |
| 0 × 3790 | 9 | 2 |

Table 3 sets up the following monitoring processes. If bit 5 in memory address location 0×0008 is changed, an interrupt, identified by code ‘0’ is generated. The coding may identify the processor or core which needs the interrupt. Likewise, interrupt ‘1’ is generated if bit 1 in memory address location 0×0008 is changed. By way of further example, an interrupt ‘2’ is generated if either bit 0 in location 0×1f000 or bit 9 in location 0×3790 is changed.

For each address location within the memory 60 which is to be monitored there would be a bank of registers within the change detect logic block 83. These registers are schematically illustrated as the register 85. These provide a cached version of the contents in the locations which are monitored. The cache logic operates by monitoring the signal transitions on the memory interface. The logic can detect when a write is occurring to a monitored location by, for example, looking at the bank enable, write strobe and address values on the memory interface. The data which is written (the ‘write data’) can then be recorded as the cached contents of that memory location in the change detect block. The first write to a monitored location would be recorded in this manner. If subsequent writes to the same monitored location are detected, the change detect block compares the new write data (existing on the memory interface) with the cached data for that location. Thus if the cached contents of a particular bit location, as specified in Table 3, differ from the contents which are being transferred to that location during the current memory write cycle, a change has been detected. The correct interrupt output, as specified in the set-up table 84, can then be triggered.

For usefully sized tables the entire register bank 85 can be analysed ‘in parallel’ such that the change detect logic can operate in a single clock cycle. It may be noted that it is not required for the cache logic to store the entire contents of a memory location being monitored. For example, it may monitor just the contents of a single bit location within that memory location. In this manner, a large number of bit fields within the memory can be monitored using a manageable number of registers and associated logic. To summarise therefore, the change detect logic, which can be implemented by a system fairly similar to that shown in FIG. 6, will monitor the address and data lines (which may be the same) of the memory bus. Address data is compared with specific addresses stored in registers to determine whether the current memory address on the bus (or even in the buffer 54) corresponds to an address stored in the bank of registers 85. If so, a selectable bit (also defined in registers 85) of the data written to that location is monitored. If this is the first request to that location the relevant bit is written to a respective register. If this is not the first request to that location there will be a comparison of the monitored bit with the stored bit to determine the retrieval of an appropriate interrupt from the look-up table 84.

It should be understood that the memory bus structure described in the foregoing and in the aforementioned co-pending applications contains quite sufficient data for this monitoring process. For example, the preferred form of memory bus structure requires the same lines to be used for the address data and the write data. However, the two are distinguished by characteristic signals on respective dedicated lines.

Thus the change detect logic has available to it those status signals which enable it to determine whether the signals appearing at any time on the memory bus are address signals or data. Thus the controls for determining which line to monitor are present in the data and memory bus structure.

In this modification the protection unit has been extended and can be regarded as a mailbox hardware assist where the term ‘mailbox’ refers to the use of the shared memory block for inter-processor communication. The assists provided are protection of the status information and accelerated and more efficient detection of status flag changes.

1. A data system comprising:
(i) a multiplicity of data processors;
(ii) a data memory;
(iii) a bus system coupling the data processors to said data memory, said bus system supporting memory transactions from said data processors to said data memory, said memory transactions each including memory address data relating to said data memory and an identification of a respective data processor in said multiplicity thereof;
(iv) at least one arbitration stage for arbitrating between memory transactions intended for said data memory; and
(v) protective means coupled to said bus system, between said one arbitration stage and said memory, said protective means comprising:
(a) storage means for storing limits defining regions of said memory allotted to respective ones of the data processors; and
(b) means responsive to a memory transaction and said storage means to determine whether said memory transaction is allowed to proceed to said data memory.

2. A data system according to claim 1 wherein said means responsive to a memory transaction includes:
means for extracting memory address data and a source identification from the memory transaction;
means responsive to said source identification to access said storage means; and
means for comparing limits provided by said storage means with said memory address data extracted from the memory transaction.

3. A data system according to claim 1 wherein said means responsive to a memory transaction comprises a state machine.

4. A data system according to claim 1 and further comprising a storage buffer for temporarily storing a memory transaction which is allowed to proceed to said data memory.

5. A data system according to claim 1 and further comprising means for storing indications of selected fields in said memory transactions and responsive to memory transactions to detect change in any of said fields and thereupon to generate an interrupt for a respective data processor.

6. A data system comprising:
(i) a multiplicity of data handling cores;
(ii) a data memory;
(iii) a bus system coupling the cores to said data memory, said bus system supporting memory transactions from said cores to said data memory, said memory transactions each including memory address data relating to said data memory and a source identification of a respective core in said multiplicity thereof; and
(iv) protective means coupled to said bus system and said memory, said protective means comprising:
(a) registers for storing source identifications and limits defining regions of said memory allotted to respective ones of the cores; and
(b) logic means responsive to a memory transaction and said storage means to determine whether said memory transaction is allowed to proceed to said data memory.

7. A data system according to claim 6 wherein said logic means includes:
means for extracting memory address data and a source identification from the memory transaction;
means responsive to said source identification to access said registers storing said limits in accordance with a match between the source identification extracted from the memory transaction and a source identification stored in the registers; and
means for comparing limits provided by said registers with said address data from the memory transaction.

8. A data system according to claim 6 wherein said logic includes a state machine.

9. A data system according to claim 6 and further comprising a storage buffer for temporarily storing a memory transaction which is allowed to proceed to said data memory.

10. A data system according to claim 6 and further comprising means for storing indications of respective fields and responsive to memory transactions to detect change in any of said fields and thereupon to generate an interrupt.

11. A data system on a chip comprising:
(i) a multiplicity of data processors;
(ii) a memory interface;
(iii) a bus system coupling the data processors to said memory interface, said bus system supporting memory transactions from said data processors to said memory interface, said memory transactions each including memory address data and an identification of a respective data processor in said multiplicity thereof;
(iv) at least one arbitration stage for arbitrating between memory transactions intended for said memory interface;
(v) protective means coupled to said bus system, between said one arbitration stage and said memory interface, said protective means comprising:
(a) storage means for storing limits defining regions of said memory allotted to respective ones of the data processors;
(b) means for extracting memory address data and a source identification from the memory transaction;
(c) means responsive to said source identification to access said storage means; and
(d) means for comparing limits provided by said storage means with said memory address data extracted from the memory transaction; and
(e) a storage buffer for temporarily storing a memory transaction which is allowed to proceed to said memory interface.

12. A data system on a chip comprising:
(i) a multiplicity of data handling cores including data processors;
(ii) a memory interface;
(iii) a bus system coupling the cores to said memory interface, said bus system supporting memory transactions from said data processors to said memory interface, said memory transactions each including memory address data and a source identification of a respective core in said multiplicity thereof; and
(iv) protective means coupled to said bus system and said memory interface, said protective means comprising:
(a) registers for storing source identifications and limits defining regions of said memory allotted to respective ones of the cores; and
(b) logic means responsive to a memory transaction and said storage means to determine whether said memory transaction is allowed to proceed to said memory interface, said logic means including:
means for extracting memory address data and a source identification from the memory transaction;
means responsive to said source identification to access said registers storing said limits in accordance with a match between the source identification extracted from the memory transaction and a source identification stored in the registers; and
means for comparing limits provided by said registers with said address data from the memory transaction.

13. A data system on a chip according to claim 12 wherein said logic means includes a state machine.

14. A data system on a chip according to claim 12 and further comprising a storage buffer for temporarily storing a memory transaction which is allowed to proceed to said memory interface.

15. A data system on a chip according to claim 12 and further comprising means for storing indications of selected fields in said memory transactions and responsive to memory transactions to detect change in any of said fields and thereupon to generate an interrupt.
